(19) United States
(12) Patent Application Publication
(10) Pub. No.: US 2019/0301432 A1
(43) Pub. Date: Oct. 3, 2019

(54) WIND TURBINE, A WIND TURBINE METEOROLGICAL INSTRUMENTATION ACCESS SYSTEM AND METHOD OF ACCESSING A METEROLOGICAL INSTRUMENTATION OF A WIND TURBINE

(71) Applicant: Siemens Gamesa Renewable Energy A/S, Brande (DK)

(72) Inventor: Travis Pless, Port St. Lucie, FL (US)

(21) Appl. No.: 15/938,685

(22) Filed: Mar. 28, 2018

(51) Int. Cl. F03D 80/50; E05B 53/00

(52) U.S. Cl. CPC F03D 80/50; E05B 53/005; F05B 2260/301; F05B 2240/2211; E05Y 2600/322

(57) ABSTRACT

A system and methods are provided for accessing a meteorological instrument on a wind turbine. The meteorological instrument is arranged on the mount structure, which includes an apex and a base. A hinge arranged on the base of the mount, the hinge pivotably connecting the mount structure to the nacelle at a first location of the nacelle. A latch securing the mount structure to the nacelle at a second location while in a closed position.

### FIELD OF THE INVENTION

The present disclosure is directed, in general, to the power generation industry, and more particularly to the field of wind power.

### BACKGROUND

Wind turbines include a nacelle which is mounted on a tower. The height of a wind turbine nacelle can be high, in some cases, over 100 feet high. Safety is a concern when repairing or inspecting parts of a wind turbine on or above the nacelle.

At a distal end from the hub and the blades, a mount structure can be mounted on the nacelle. The mount structure, for example spar or tail, extends upward from the nacelle and comprises a meteorological instrument. By way of the mount structure, the meteorological instrument is mounted above the nacelle.

At the end away from the blades, a rear region, the mount structure is bolted to the nacelle and at the end closer to the blades the mount structure is attached by a hinge. The bolts must be removed prior to being able to pivot the mount. The bolts may be difficult to reach by a technician. For example, the bolts may be located at or near the rear end of the nacelle. Accessing the bolts may be hazardous to the technician. Removing the bolts may be time consuming.

Other ways to access the meteorological instrumentation on a wind turbine are needed

### SUMMARY

Variously disclosed embodiments include systems and methods that may be used to facilitate and access to instrument on a wind turbine.

In one example, A wind turbine meteorological instrument access system is provided. The wind turbine includes a nacelle, which includes a hub and at least one blade attached to the hub. The system may include a mount structure including an apex and a base. A meteorological instrument is arranged on the mount structure. A hinge is arranged on the base of the mount. The hinge pivotably connecting the mount structure to the nacelle at a first location of the nacelle. A latch secures the mount structure to the nacelle at a second location while in a closed position. Wherein the first location is closer to the hub than the second location, and wherein the mount structure is prevented from pivoting at hinge wile in the closed position.

In another example, a method of accessing a wind turbine meteorological instrument is provided. The wind turbine may include a nacelle and a mount structure. The mounts structure may be attached to or near a rear end region of the nacelle and includes the meteorological instrument. The nacelle includes a hub and at least one blade attached to the hub. The method includes pulling a pull release which actuates a release of a latch. The latch is arranged on the mount structure and secures the mount structure to the nacelle. The mount structure is pivoted towards the front region of the wind turbine, whereby the meteorological is moved closer to the nacelle and is assessable by a technician.

In a further example, a method of retrofitting a mount structure with the access system is provided. The method may include removing the bolts connecting the mount structure to the nacelle. A first latch section of the latch is attached to the nacelle, and a second latch section of the latch is attached to the mount structure, the second latch section aligned with the first latch section to engage therewith, wherein one of the latch sections is attached to the pull release;

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIGS. 1 and 2 illustrates side views of a wind turbine that facilitates carrying out one or more of the embodiments described herein.

FIG. 3 illustrates a view of the access system that facilitates carrying out one or more of the embodiments described herein.

### DETAILED DESCRIPTION

Various technologies that pertain to methods and systems that facilitate accessing an instrument on a mounting structure of a wind turbine will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

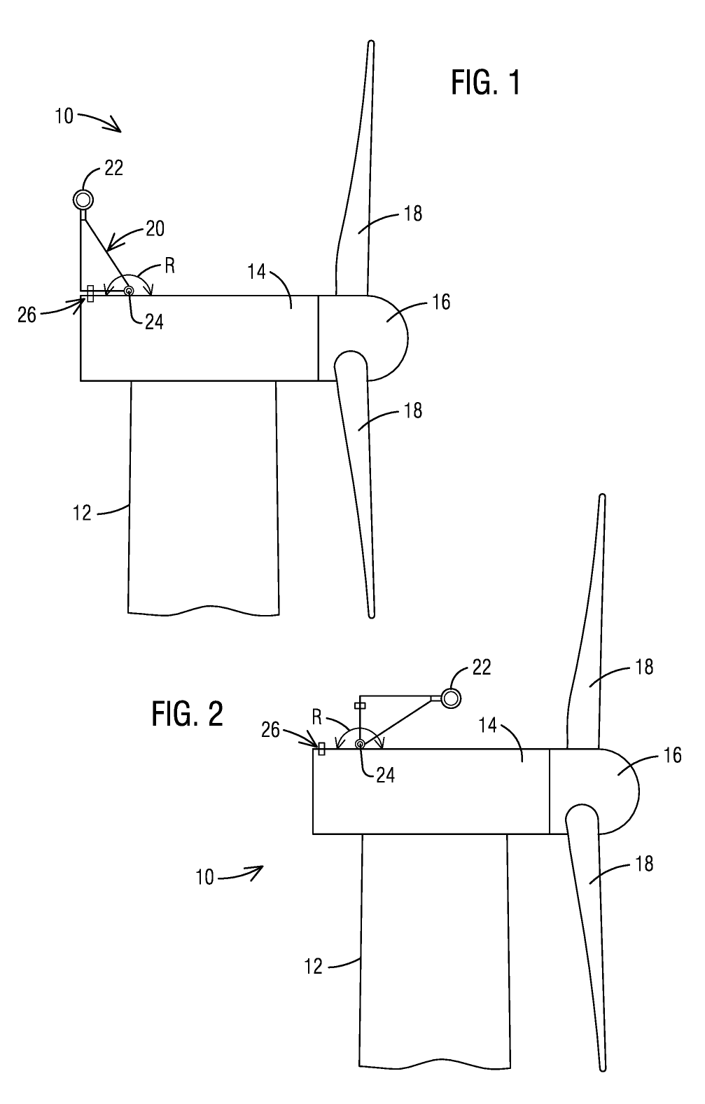

FIG. 1 illustrates a side view of a wind turbine 10 that facilitates carrying out one or more of the embodiments described herein. The wind turbine 10 comprises a tower 12 and a nacelle 14, which is supported by the tower. The wind turbine 10 comprises a hub 16 attached to one end, at a front region, of the nacelle 14. One or more blades 18 may be attached to the hub 16.

At a rear region, an end opposite from the hub 18, a meteorological mount structure 20 is attached to the nacelle 14. The mount structure 20 is any structure capable of supporting a meteorological instrument 22. For example, the mount structure 20 may be a spar or tail. The instrument 22 is mounted via the mount at an elevation above the nacelle. The instrument 22 may be mounted at or substantially near the apex of the mount structure 20. The mount structure 20 comprises, for example, a meteorological instrument 22 sufficient to measure a wind condition. In an embodiment, the instrument 22 is an anemometer for measuring a wind speed or velocity.

At a base section of the mount structure 20, the mount structure 20 is pivotably attached to the nacelle 14. For example, the mount structure 20 may be attached to the nacelle 14 by a hinge 24. The hinge 24 is arranged on the end of the mount structure 20 nearest the hub 16 and provides a pivot point in which the mount structure 20 may rotate R about. At an end opposite to the hinge, a latch 26 is arranged which secures the mount structure 20 to the nacelle 14.

FIG. 1 illustrates a closed position of the mount structure 20. In a closed position, the mount structure 20 is secured to the nacelle 14 via the latch 26. In the closed position, the latch 26 prevents movement of the mount structure 20.

FIG. 2 illustrates a side view of an example mount structure 20 in an open position. In the open position, the latch 26 is released. The mount structure 20 is pivoted about the hinge 24 in the direction of the hub 16, in the open position. This moves the instrumentation 22 closer to the nacelle making it accessible. The access allows for inspection and or repair of the instrumentation 22.

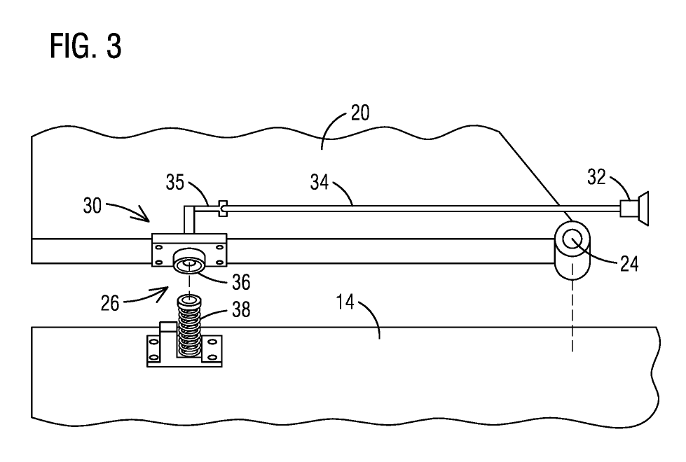

FIG. 3 illustrates a view of the access system 30 that facilitates carrying out one or more of the embodiments described herein. The access system 30 includes the latch 26 and a pull release 34. Access systems comprising a latch and which enable a remote release of a latch are known. Remote being a distance away from the latch. Example access systems are types used to secure and release a car hood giving access to equipment under the hood.

In an embodiment of the access system 30, a pull release 34 is connected to the latch 26. The pull release extends from the latch 26 towards the hinge 24. The pull release 34 may extend to or substantially near the hinge 24. The pull release 34 may extend past the hinge 24. When pulled at an end remote from the latch 26, the pull release 34 actuates a release of the latch 26. The pull release 34 may comprise a grip 32 on the hinge 24 side. For example, the grip 32 may be a handle, pull, or nob. The pull release 34 may be formed of any structure sufficient to allow be pulled and actuate the release of the latch 26. The pull release 34 may be rigid, for example a rod. A flexible pull release 34, for example a cable, may be used.

Latches 26 are known in the art. A latch, also known as a catch, is a type of mechanical fastener that joins two objects or surfaces while allowing for their regular separation. Any type of latch providing a secure connection may be used. Various types of latches are known, for example comprising a striker and keeper type and spring bolt latch type. Merely for illustrative purposes, FIG. 3 is shown with a spring bolt latch type.

The latch 26 includes a first latch section 36 and a second latch section 38, which engages with the first latch section 36 to form a secure connection. When the first latch section 36 is attached to the nacelle 14 the second latch section 38 is attached to the mount structure 20. When the first latch section 36 is attached to the mount structure 20 the second latch section 38 is attached to the nacelle 14.

The latch 26 may include a lever arm 35 arranged on one of the first or second latch sections 36, 38 of the latch 26. The pull release 34 may be connected to the latch 26 via the lever arm 36 which when pulled, disengages the first latch section 36 from the second potion 38.

A spring bolt latch system using compressed to keep the bolt locked into position is illustrated in FIG. 3.

A method of accessing a wind turbine meteorological instrument may include pulling a pull release a mount structure actuating a release of a latch. The latch being arranged on the mount structure and secures the mount structure to the nacelle as described above. The mount structure is pivoted towards the front region of the wind turbine. The pivoting moving the meteorological instrument to be assessable by a technician. The pull release is remote from the latch. The technician may therefore remain in a safer region of the nacelle when pulling the release pull. Pulling of the pull release may be in the direction of the front of the wind turbine. This also add to the safety of the technician to not have the mount structure in the way when pulling the pull release.

The wind turbine which has the mount system bolted to the nacelle may be retrofitted with the access system. The bolts connecting the mount structure to the nacelle would be removed and replaced bye the access system The replacement may include attaching a first latch section of the latch to the nacelle; and attaching a second latch section of the latch to the mount structure, the second latch section aligned with the first latch section to engage therewith,

By way of the access system 30 the instrumentation 22 mounted on the mount structure 20 may be accessed easier than by previously known systems. By providing a pull release 34 remotely to the latch, a safer way to access the instrumentation 22, than the known systems and methods, is provided. The access system 30 facilitates a quick and easy way to access the instrumentation 22.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise. Further, the phrase “based on” is intended to mean “based, at least in part, on” unless explicitly stated otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

What is claimed is:

1. A wind turbine meteorological instrument access system, the wind turbine comprising a nacelle, which comprises a hub and at least one blade attached to the hub, the system comprising:
a mount structure comprising an apex and a base, a meteorological instrument arranged on the mount structure;
a hinge arranged on the base of the mount, the hinge pivotably connecting the mount structure to the nacelle at a first location of the nacelle; and
a latch securing the mount structure to the nacelle at a second location while in a closed position,
wherein the first location is closer to the hub than the second location, and
wherein the mount structure is prevented from pivoting at hinge wile in the closed position.

2. The system according to claim 2,
wherein a pull release is connected to the latch and extending toward the first location, the pull release is connected to the latch to actuate a release when the latch release is pulled at a location remote from the latch.

3. The system according to claim 2,
wherein the pull release comprises a rod.

4. The system according to claim 2,
wherein the pull release comprises a cable.

5. The system according to claim 2,
wherein the latch release comprises a grip the first location end.

6. The system according to claim 1,
wherein the latch uncouples the mount structure from the nacelle.

7. The system according to claim 2,
wherein the mount structure is pivoted about at the hinge while in the open position.

8. The system according to claim 2,
wherein the mount structure pivots about the hinge so that the apex of mount structure moves towards the hub in the open position.

9. The system according to claim 8,
wherein the mount structure pivoted so that the apex of mount structure moves towards the nacelle in the open position.

10. A method of accessing a wind turbine meteorological instrument, the wind turbine comprising a nacelle and a mount structure, the mounts structure attached to a rear end region of the nacelle and comprising the meteorological instrument, the nacelle comprises a hub and at least one blade attached to the hub, the method comprising:
pulling a pull release which actuates a release of a latch, the pull release is arranged on the mount structure and secures the mount structure to the nacelle; and
pivoting the mount structure towards the front region of the wind turbine,
whereby the meteorological is moved closer to the nacelle and is assessable by a technician.

11. The method according to claim 10,
wherein the pulling is in a direction of the front region of the wind turbine.

12. The method according to claim 10,
wherein the pulling is in a location remote from the latch.

13. A method of retrofitting a mount structure with the access system of claim 1: comprising
removing the bolts connecting the mount structure to the nacelle;
attaching a first latch section of the latch to the nacelle; and
attaching a second latch section of the latch to the mount structure, the second latch section aligned with the first latch section to engage therewith,
wherein one of the latch sections is attached to the pull release.
